(19) United States
(12) Patent Application Publication
(10) Pub. No.: US 2013/0288127 A1
(43) Pub. Date: Oct. 31, 2013

(54) PRODUCTION METHOD OF CARBON MATERIAL FOR SODIUM SECONDARY BATTERY

(71) Applicants: Shingo Matsumoto, Tsukuba-shi (JP); Taketsugu Yamamoto, Tsukuba-shi (JP); Junji Suzuki, Niihama-shi (JP)

(72) Inventors: Shingo Matsumoto, Tsukuba-shi (JP); Taketsugu Yamamoto, Tsukuba-shi (JP); Junji Suzuki, Niihama-shi (JP)

(73) Assignee: SUMITOMO CHEMICAL COMPANY, LIMITED, Chuo-ku, Tokyo (JP)

(21) Appl. No.: 13/979,049

(22) PCT Filed: Dec. 12, 2011
(86) PCT No.: PCT/JP2011/078699

§ 371 Date: Jul. 10, 2013

(30) Foreign Application Priority Data
Jan. 12, 2011 (JP) 2011-003776

(51) Int. Cl. H01M 4/133; H01M 4/131; H01M 4/62; H01M 4/1393

(52) U.S. Cl. CPC H01M 4/133; H01M 4/1393; H01M 4/131; H01M 4/622
USPC 429/217; 423/445 R; 429/231.8; 429/221; 429/223; 429/224; 429/231.2; 429/231.3; 429/231.5; 429/231.6

(57) ABSTRACT

The invention provides a method for producing a carbon material as a negative electrode active material that can dope and undope a sodium ion. The production method of a carbon material for a sodium secondary battery includes a step of heating at a temperature of 800 to 2500° C. a compound according to Formula (1), Formula (2) or Formula (3), and having 2 or more oxygen atoms, or a mixture of an aromatic derivative 1 having an oxygen atom in the molecule and an aromatic derivative 2 having a carboxyl group in the molecule and being different from the aromatic derivative 1.

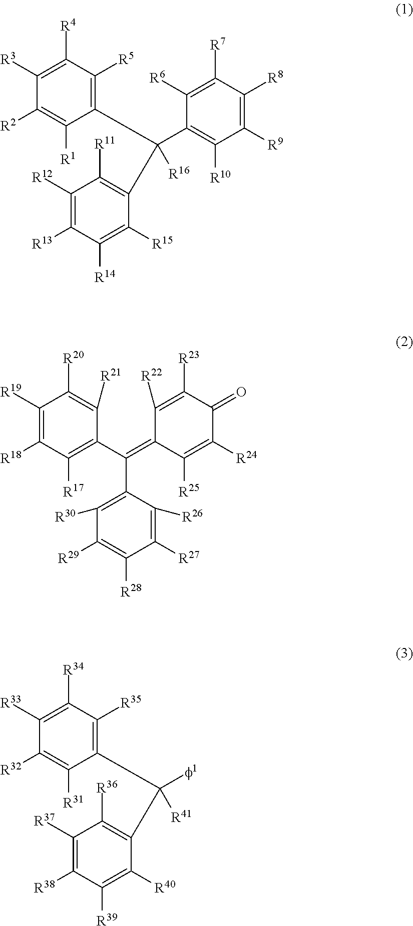

### TECHNICAL FIELD

The present invention relates to a production method of the carbon material for a sodium secondary battery.

### BACKGROUND ART

Since a sodium secondary battery can generate higher voltage compared to a battery of an aqueous electrolytic solution, it has high energy density and is suitable for a high capacity battery. Furthermore, since resources for sodium are abundant and sodium is an inexpensive material, it has been expected that a large number of large scale power sources can be supplied by putting into practical use an active material constituting a sodium secondary battery.

A sodium secondary battery usually includes a positive electrode having a positive electrode active material that can dope and undope a sodium ion, a negative electrode having a negative electrode active material that can dope and undope a sodium ion, and an electrolyte.

As a negative electrode active material that can dope and undope a sodium ion, use of a carbon material other than graphite has been proposed (Patent Literature 1).

### CITATION LIST

### Patent Literature

Patent Literature 1: Japanese Unexamined Patent Publication No. 2010-251283

### SUMMARY OF INVENTION

### Technical Problem

In order to produce a carbon material as a negative electrode active material that can dope and undope a sodium ion, generally a production method including carbonization of a polymer such as a phenolic resin is used. However, development of production methods for various carbon materials corresponding to end uses is expected.

A polymer is obtained by polymerizing small molecules generally referred to as monomers, and a carbon material is produced by calcining the polymer obtained in the polymerization step under an inactivated gas atmosphere. Since the production process can be simplified by avoiding use of a polymer as an intermediate, development of a production method for producing a carbon material directly from small molecules is expected.

Further, in the case of a heat-curable polymer such as a phenolic resin, once it is cured by polymerization, a limit in handling during carbonization treatment may occur, and a grinding step is necessary in order to form a granular of 100 μm or less.

### Solution to Problem

The inventors studied diligently to solve the problem, thereby completing the present invention. In other words, the present invention provides the following [1] to [8].

[1] A production method of a carbon material for a sodium secondary battery comprising heating at a temperature of 800 to 2500° C. one or more organic compounds selected from the group consisting of an organic compound 1 and an organic compound 2;

wherein the organic compound 1 is an organic compound represented by the formula (1), the formula (2), or the formula (3), and having 2 or more oxygen atoms in the each formula:

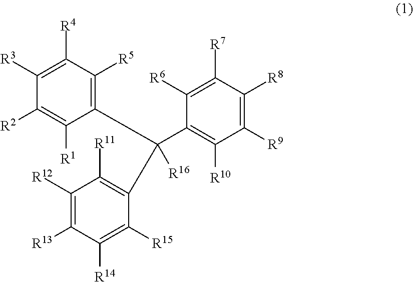

wherein R¹ to R¹⁶ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group,

wherein R⁵ and R⁶ together may represent —O—, and

wherein R¹⁵ and R¹⁶ together may represent —CO—O— or —SO₂—O—;

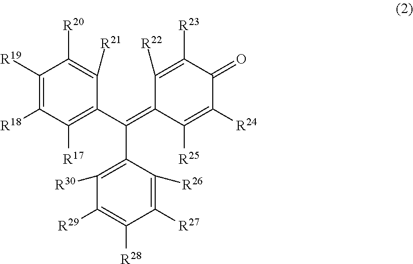

wherein R¹⁷ to R³⁰ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group, and

wherein R²¹ and R²² together may represent —O—;

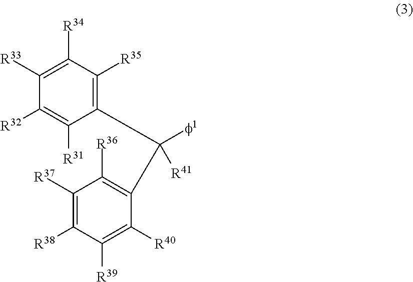

wherein R³¹ to R⁴¹ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group,

wherein R⁴⁰ and R⁴¹ together may represent —CO—O— or —SO₂—O—, and

wherein φ¹ represents an optionally substituted allyl group, an optionally substituted cyclopentadiene group, or an optionally substituted aromatic heterocyclic group; and

wherein the organic compound 2 is a mixture of an aromatic derivative 1 having an oxygen atom in the molecule and an aromatic derivative 2 having a carboxyl group in the molecule and being different from the aromatic derivative 1.

[2] The production method according to [1] above, wherein, as to the organic compound 1, R⁵ and R⁶ together represents —O—, and/or R¹⁵ and R¹⁶ together represents —CO—O— or —SO₂—O— in the formula (1).

[3] The production method according to [1] or [2] above, wherein any one of R¹ to R⁵ is a hydroxy group, an alkoxy group, or an acyl group, and any one of R⁶ to R¹⁰ is a hydroxy group, an alkoxy group, or an acyl group.

[4] The production method according to any of [1] to [3] above, wherein any one of R¹⁷ to R²¹ is a hydroxy group, an alkoxy group, or an acyl group, and any one of R²² to R²⁵ is a hydroxy group, an alkoxy group, or an acyl group.

[5] The production method according to any of [1] to [4] above, wherein, as to the organic compound 2, the aromatic derivative having an oxygen atom is phenol, resorcinol, or cresol, and the aromatic derivative having a carboxyl group is phthalic anhydride.

[6] A sodium secondary battery comprising a first electrode including the carbon material for a sodium secondary battery produced by the production method according to any of [1] to [5] above, and a binding agent; a second electrode; and an electrolyte.

[7] The sodium secondary battery according to [6] above, wherein the second electrode comprises a transition metal compound containing sodium represented by the following formula (A):

NaₓMO₂ (A)

wherein M is at least one element selected from the group consisting of Fe, Ni, Co, Mn, Cr, V, Ti, B, Al, Mg and Si; and x is more than 0 but not more than 1.2.

[8] The sodium secondary battery according to [6] or [7] above, wherein the binding agent comprises a non-fluorinated resin.

### Advantageous Effects of Invention

Using a production method according to the present invention, a carbon material for a sodium secondary battery can be obtained without a step to produce a polymer. Further, by utilizing a specific low-molecular-weight organic substance, handling of a source material becomes easier, degree of flexibility in a production method for a carbon material becomes greater, and the present invention is industrially very useful.

### DESCRIPTION OF EMBODIMENTS

The present invention will be described in detail. First, a production method of a carbon material for a sodium secondary battery as a production method of a negative electrode material for a sodium secondary battery will be described.

A production method of a carbon material for a sodium secondary battery according to the present invention includes heating one or more organic compounds selected from the group consisting of an organic compound 1 and an organic compound 2 at a temperature of 800 to 2500° C.

The organic compound 1 is represented by formula (1), formula (2), or formula (3), and has 2 or more oxygen atoms in the relevant formula.

The formula (1) is as follows.

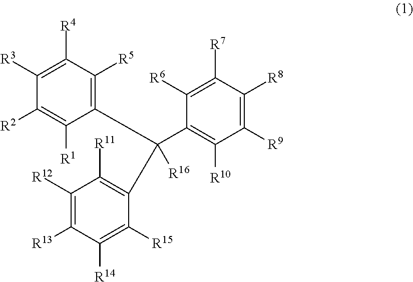

In the formula (1) R¹ to R¹⁶ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group; R⁵ and R⁶ together may represent —O—; and R¹⁵ and R¹⁶ together may represent —CO—O— or —SO₂—O—.

As to the organic compound 1, preferably R⁵ and R⁶ together represents —O— and/or R¹⁵ and R¹⁶ together represents —CO—O— or —SO₂—O— in the formula (1).

While, preferably any one of R¹ to R⁵ is a hydroxy group, an alkoxy group, or an acyl group, and any one of R⁶ to R¹⁰ is a hydroxy group, an alkoxy group, or an acyl group.

The formula (2) is as follows.

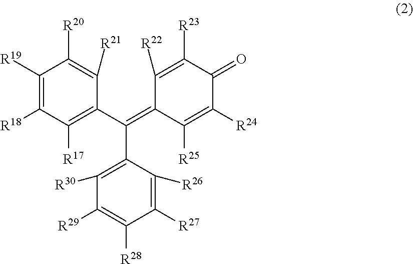

In the formula (2) R¹⁷ to R³⁰ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group, and R²¹ and R²² together may represent —O—.

Preferably any one of R¹⁷ to R²¹ is a hydroxy group, an alkoxy group, or an acyl group, and any one of R²² to R²⁵ is a hydroxy group, an alkoxy group, or an acyl group.

The formula (3) is as follows.

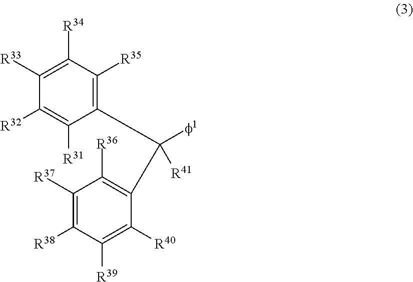

In the formula (3) R³¹ to R⁴¹ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group; R⁴⁰ and R⁴¹ together may represent —CO—O— or —SO₂—O—; and wherein φ¹ represents an optionally substituted allyl group, an optionally substituted cyclopentadiene group, or an optionally substituted aromatic heterocyclic group.

Examples of the organic compound 1 include m-cresol purple, phenol red, phenolphthalein, o-cresolphthalein, phenolphthalein, fluorescein, fluorescein eosin, and thymol blue.

The organic compound 2 is a mixture of an aromatic derivative 1 having an oxygen atom in the molecule and an aromatic derivative 2 having a carboxyl group in the molecule and being different from the aromatic derivative 1.

With respect to the organic compound 2, the aromatic derivative having an oxygen atom is preferably phenol, resorcinol, or cresol, and the aromatic derivative having a carboxyl group is preferably phthalic anhydride.

The heating temperature is 800 to 2500° C. as described above, but preferably 1000 to 2100° C., and even more preferably 1200 to 2000° C. The heating time is preferably 1 min to 24 hours.

The atmosphere is preferably an inert gas atmosphere (e.g. nitrogen, and argon). When a heat treatment is carried out under an inert gas atmosphere, a closed container containing an organic source material is put under an inert gas atmosphere, may be closed and heat-treated, or a heat-treatment may be carried out while allowing an inert gas to flow through the container containing an organic source material.

A heat treatment is preferably carried out in a calcination furnace, such as a ring furnace, a rotary kiln, a roller hearth kiln, a pusher kiln, a multihearth furnace, a fluidized-bed furnace, and a high temperature calcination furnace.

Before a heat treatment step, a stabilization step for heating an organic source material in an oxidizing gas atmosphere, or a pre-heating step for heating it in an inert gas atmosphere may be included.

To explain in detail, a stabilization step is a step of treatment in an oxidizing gas atmosphere, such as air, H₂O, CO₂ and O₂, usually at 400° C. or lower.

At the stabilization step, a part or all organic compounds 1 and 2 are cross-linked to increase the molecular weights, and/or a part or all of organic compounds 1 and 2 are carbonized.

The treatment at the stabilization step is preferably carried out using a calcination furnace, such as a ring furnace, a rotary kiln, a roller hearth kiln, a pusher kiln, a multihearth furnace, a fluidized-bed furnace, and a high temperature calcination furnace.

To explain in detail, a pre-heating step is a step for heat-treating an organic source material in an inert gas atmosphere such as N₂ or Ar usually at 400° C. or lower.

Also at the pre-heating step, a part or all of organic compounds 1 and 2 are cross-linked to increase the molecular weights, and/or a part or all of organic compounds 1 and 2 are carbonized.

Also the treatment at the stabilization step is preferably carried out using a calcination furnace, such as a rotary kiln, a roller hearth kiln, a pusher kiln, a multihearth furnace, a fluidized-bed furnace, and a high temperature calcination furnace.

The production method according to the present invention may include a step for forming organic compounds 1 and 2 into a granular form. For the step for forming a granular may utilize a variety of steps, such as a step for grinding aggregate organic compounds 1 and 2, or a step for obtaining fine particles by spray-drying compounds 1 and 2 dissolved in a solvent, or compounds 1 and 2.

For the step for grinding organic compounds 1 and 2, a fine grinding mill including an impact attrition mill such as a jet mill; a centrifugal mill; a ball mill, such as a tube mill, a compound mill, a conical ball mill, and a rod mill; a vibration mill; a colloid mill; and a disk attrition mill; can be preferably used. A jet mill and a ball mill are more preferable, and if a ball mill is used, milling media or a mill casing should further preferably be made of a non-metal, such as alumina or agate, to avoid contamination of a metal powder.

For the step for obtaining fine particles by spray-drying compounds 1 and 2, a spray dryer may be used.

A step for milling a carbon material yielded by a heat treatment at 800 to 2500° C. may be further included. For such milling, a fine grinding machine including an impact attrition mill machine such as a jet mill; a centrifugal mill; a ball mill, such as a tube mill, a compound mill, a conical ball mill, and a rod mill; a vibration mill; a colloid mill; and a disk attrition mill; can be preferably used. A jet mill and a ball mill are more preferable, and if a ball mill is used, milling media or a mill casing should further preferably be made of a non-metal, such as alumina or agate, to avoid contamination of a metal powder.

The median size (volume-based) of a carbon material obtained at the grinding step is usually 4 to 10 μm.

A carbon material produced by a production method of a carbon material according to the present invention can dope and undope a sodium ion. Therefore, it can be used as an electrode for a sodium secondary battery.

A sodium secondary battery according to the present invention has a first electrode including a carbon material produced by a production method of a carbon material according to the present invention, and a binding agent; a second electrode; and an electrolyte; and usually the first electrode is a negative electrode and the second electrode is a positive electrode. Furthermore, there is usually a separator between the positive electrode and the negative electrode.

The components of a sodium secondary battery according to the present invention will be described below.

(1) Negative Electrode

There is no restriction on a negative electrode insofar as it contains a carbon material produced by a production method of a carbon material according to the present invention. Examples thereof include an electrode constituted with a negative electrode current collector supporting a negative electrode mixture containing the carbon material, and an electrode constituted solely with a negative electrode material.

The negative electrode mixture may, if necessary, contain a binding agent, or an electroconductive material. In this regard, the electroconductive material is different from a carbon material according to the present invention.

<Binding Agent>

Although both a fluorinated resin and a non-fluorinated resin can be used as a binding agent to be used for the negative electrode mixture, a non-fluorinated resin is more preferable.

Examples of a fluorinated resin include a C1 to C18 fluorinated alkyl(meth)acrylate, a perfluoroalkyl(meth)acrylate [e.g. perfluorododecyl(meth)acrylate, perfluoro-n-octyl(meth)acrylate, and perfluoro-n-butyl(meth)acrylate];

a perfluoroalkyl substituted-alkyl(meth)acrylate [e.g. perfluorohexylethyl(meth)acrylate, and perfluorooctylethyl(meth)acrylate];

a perfluorooxyalkyl(meth)acrylate [e.g. perfluorododecyloxyethyl(meth)acrylate, and perfluorodecyloxyethyl(meth)acrylate];

a C1 to C18 fluorinated alkyl crotonate;

a C1 to C18 fluorinated alkyl malate and fumarate;

a C1 to C18 fluorinated alkyl itaconate; and

a fluorinated alkyl-substituted olefin (carbon number 2 to about 10, and fluorine atom number 1 to about 17) [e.g. perfluorohexylethylene, tetrafluoroethylene, trifluoroethylene, polyvinylidene fluoride (hereinafter occasionally referred to as “PVdF”), and hexafluoropropylene].

Next, examples of a non-fluorinated resin include an addition polymer of a monomer having an ethylenic double bond containing no fluorine atom. Examples of such a monomer include a (meth)acrylic acid ester type monomer, such as:

a C1 to C22 (cyclo)alkyl(meth)acrylate [e.g. methyl(meth)acrylate, ethyl(meth)acrylate, n-butyl(meth)acrylate, isobutyl(meth)acrylate, cyclohexyl(meth)acrylate, 2-ethylhexyl(meth)acrylate, isodecyl(meth)acrylate, lauryl(meth)acrylate, and octadecyl(meth)acrylate];

an aromatic ring-containing (meth)acrylate [e.g. benzyl(meth)acrylate, and phenylethyl(meth)acrylate];

a mono(meth)acrylate of an alkylene glycol or a dialkylene glycol (carbon number of an alkylene group is 2 to 4) [e.g. 2-hydroxyethyl(meth)acrylate, 2-hydroxypropyl(meth)acrylate, and diethylene glycol mono(meth)acrylate];

a (poly)glycerol (degree of polymerization 1 to 4) mono(meth)acrylate; and

a multifunctional (meth)acrylate [e.g. (poly)ethylene glycol (degree of polymerization 1 to 100) di(meth)acrylate, (poly)propylene glycol (degree of polymerization 1 to 100) di(meth)acrylate, 2,2-bis(4-hydroxyethylphenyl)propane di(meth)acrylate, and trimethylol propane tri(meth)acrylate];

a (meth)acrylamide type monomer, such as (meth)acrylamide and a derivative of (meth)acrylamide [e.g. N-methylol(meth)acrylamide, and diacetone acrylamide];

a monomer containing a cyano group, such as (meth)acrylonitrile, 2-cyanoethyl(meth)acrylate, and 2-cyanoethyl acrylamide;

a styrenic monomer, such as styrene and a C7 to C18 styrene derivative [e.g. α-methylstyrene, vinyl toluene, p-hydroxystyrene, and divinylbenzene];

a diene monomer, such as a C4 to C12 alkadiene [e.g. butadiene, isoprene, and chloroprene];

an alkenyl ester type monomer, such as a C2 to C12 carboxylic acid vinyl ester [e.g. vinyl acetate, vinyl propionate, vinyl butyrate, and vinyl octanoate]; and a C2 to C12 carboxylic acid(meth)allyl ester [e.g. (meth)allyl acetate, (meth)allyl propionate, and (meth)allyl octanoate];

a monomer containing an epoxy group, such as glycidyl(meth)acrylate, and (meth)allyl glycidyl ether;

monoolefins, such as a C2 to C12 monoolefin [e.g. ethylene, propylene, 1-butane, 1-octene, and 1-dodecene];

a monomer containing a chlorine, bromine or iodine atom;

a monomer containing a halogen atom other than fluorine [e.g. vinyl chloride, and vinylidene chloride];

(meth)acrylic acids [e.g. acrylic acid and methacrylic acid]; and

a monomer having conjugated double bonds [e.g. butadiene, and isoprene].

As an addition polymer, a copolymer, such as an ethylene/vinyl acetate copolymer, a styrene/butadiene copolymer and an ethylene/propylene copolymer, may be also used. A carboxylic acid vinyl ester polymer may be saponified partly or completely. As a binding agent, a copolymer of a fluorine compound and a monomer having an ethylenic double bond but no fluorine atom may be also used.

Other examples of a binding agent include polysaccharides and derivatives thereof, such as starch, methyl cellulose, carboxymethyl cellulose, hydroxymethyl cellulose, hydroxyethyl cellulose, hydroxypropyl cellulose, carboxymethyl hydroxyethyl cellulose, and nitrocellulose; a phenol resin; a melamine resin; a polyurethane resin; a urea resin; a polyamide resin; a polyimide resin; a polyamide-imide resin; petroleum pitch; and coal pitch.

As a binding agent a non-fluorinated resin is especially preferable. Further, at a step for coating onto a current collector, for facilitating coating onto a current collector, a thickener or a viscosity reducer may be used.

Examples of a negative electrode current collector include Cu, Ni, stainless steel, and Al, and from a viewpoint of hardly alloying with sodium and of easily fabricating a thin membrane, Cu is preferable.

Examples of a shape of a negative electrode current collector include a foil form, a planar form, a mesh form, a net form, a metallic lath form, a punching metal form, an embossed form, and a combined form thereof (e.g. a meshed planar form). A negative electrode current collector surface may form roughness by etching treatment.

Examples of a method for supporting a negative electrode mixture on a negative electrode current collector support include a compression molding method, and a method of forming a paste using an organic solvent, etc., coating it on a negative electrode current collector, dying and pressing the coat to be fixed firmly. Examples of a coating process for coating a negative electrode mixture on a negative electrode current collector include a slot die coating process, a screen coating process, and a bar coating process.

(2) Positive Electrode

A positive electrode is composed of a positive electrode current collector and a positive electrode mixture supported on the positive electrode current collector. The positive electrode mixture contains a positive electrode active material as well as, if necessary, an electroconductive material and a binding agent.

Examples of the electroconductive material include a carbon material such as Ketjen black different from a carbon material according to the present invention.

There is no restriction on a positive electrode active material, insofar as it is a material allowing doping and undoping a sodium ion, and examples thereof include a sulfide such as TiS₂, an oxide such as Fe₃O₄, a sulfate such as Fe₂(SO₄)₃, a phosphate such as FePO₄, and a fluoride such as FeF₃. Especially preferable is a sodium transition metal compound, which is a compound of sodium and a transition metal element. In this case, one or more transition metal elements may be selected appropriately for the sodium transition metal compound, and specific examples thereof include Ti, V, Cr, Mn, Fe, Co, Ni and Cu.

As a sodium transition metal compound, a transition metal compound containing sodium represented by the following formula (A) is preferable.

NaₓMO₂ (A)

wherein M is one or more elements selected from the group consisting of Fe, Ni, Co, Mn, Cr, V, Ti, B, Al, Mg and Si, and x is more than 0 but not more than 1.2. Specific and favorable examples thereof include an oxide such as NaMnO₂, NaNiO₂ and NaCoO₂ having the same structure as α-NaFeO₂, as well as NaFe_{1-p-q}MnₚNi_{q}O₂ (wherein p and q satisfy the following relationship: 0≦p+q≦1, 0≦p≦1, and 0≦q≦1.

Examples of another sodium transition metal compound include an oxide expressed by NaₓM¹O_{y} (M¹ represents at least one transition metal element, and x and y are values satisfying 0.4<x<2, and 1.9<y<2.1);

a silicate expressed by Na_{b}M²_{c}Si₁₂O₃₀ (M² represents at least one transition metal element, and b and c are values satisfying 2≦b≦6, and 2≦c≦5), such as Na₆Fe₂Si₁₂O₃₀ and Na₂Fe₅Si₁₂O₃₀;

a silicate expressed by Na_{d}M³ₑSi₆O₁₈ (M³ represents at least one transition metal element, and d and e are values satisfying 3≦d≦6, and 1≦e≦2), such as Na₂Fe₂Si₆O₁₈ and Na₂MnFeSi₆O₁₈;

a silicate expressed by Na_{f}M⁴_{g}Si₂O₆ (M⁴ represents at least one element selected from the group consisting of transition metal elements, Mg and Al, and f and g are values satisfying 1≦f≦2, and 1≦g≦2), such as Na₂FeSiO₆;

a phosphate expressed by NaM⁶ₐPO₄ (M⁶ represents at least one transition metal element), such as NaFePO₄, NaMnPO₄, and NaNiPO₄;

a phosphate such as Na₃Fe₂(PO₄)₃;

a sulfate such as NaFeSO₄F;

a borate such as NaFeBO₄ and Na₃Fe₂(BO₄)₃; and

a fluoride expressed by NaₕM⁵F₆ (M⁵ represents at least one transition metal element, and h is a value satisfying 2≦h≦3), such as Na₃FeF₆ and Na₂MnF₆;

and the above may be used singly or in a combination of 2 or more thereof.

With respect to the sodium transition metal compound, a part of the transition metal element may be substituted with another metal element other than the transition metal elements, insofar as advantageous effects of the invention be not impaired. In some cases, the property of an assembled battery according to the present invention may be improved by the substitution. Examples of such another metal other than the transition metal elements include metal elements, such as Li, K, Ag, Mg, Ca, Sr, Ba, Al, Ga, In, Zn, Sc, Y, La, Ce, Pr, Nd, Sm, Eu, Gd, Tb, Ho, Er, Tm, Yb and Lu.

There is no restriction on a positive electrode current collector, insofar as it has high electrical conductivity and is formed easily to a thin membrane, and a metal, such as Al, Ni, stainless steel, and Cu, may be used. Examples of the positive electrode current collector shape include foil, planar, mesh, net, metallic lath, punching metal, embossed, and a combined thereof (e.g. a meshed planar form).

As the electroconductive material, a carbon material may be used, and examples of the carbon material include a graphite powder, carbon black, and a fibrous carbon material such as a carbon nanotube. Preferably, a carbon material produced by a production method of a carbon material for a sodium secondary battery according to the present invention is used.

Examples of a binding agent to be used in a positive electrode mixture include binding agents similar to those used for a negative electrode mixture, and a non-fluorinated resin is preferable as a binding agent used in a negative electrode mixture.

Examples of a method for supporting a positive electrode mixture on a positive electrode current collector, which is similar to a method for supporting a negative electrode mixture on a negative electrode current collector, include a compression molding method, and a method of forming a paste using an organic solvent, etc., coating it on a negative electrode current collector, dying and pressing the coat to be fixed firmly. Examples of a coating process for coating a negative electrode mixture on a negative electrode current collector include a slot die coating process, a screen coating process, and a bar coating process.

(3) Electrolyte

Next, an electrolyte will be described. Examples of an electrolyte include NaClO₄, NaPF₆, NaAsF₆, NaSbF₆, NaBF₄, NaCF₃SO₃, NaN(SO₂CF₃)₂, a lower aliphatic carboxylic acid sodium salt, and NaAlCl₄, and a combination of 2 or more thereof may be also used. Among these, use of at least one selected from the group containing fluorine consisting of NaPF₆, NaAsF₆, NaSbF₆, NaBF₄, NaCF₃SO₃ and NaN(SO₂CF₃)₂ is preferable. According to the present invention, an electrolyte is used preferably in a condition dissolved in an organic solvent (liquid form), namely as a nonaqueous electrolytic solution.

Examples of an organic solvent in a nonaqueous electrolytic solution include carbonates, such as propylene carbonate, ethylene carbonate, dimethyl carbonate, diethyl carbonate, ethyl methyl carbonate, isopropyl methyl carbonate, vinylene carbonate, 4-trifluoromethyl-1,3-dioxolane-2-one, and 1,2-di(methoxycarbonyloxy)ethane; ethers, such as 1,2-dimethoxy ethane, 1,3-dimethoxy propane, pentafluoropropyl methyl ether, 2,2,3,3-tetrafluoropropyl difluoromethyl ether, tetrahydrofuran, and 2-methyltetrahydrofuran; esters, such as methyl formate, methyl acetate, and γ-butyrolactone; nitriles, such as acetonitrile, and butyronitrile; amides, such as N,N-dimethylformamide, and N,N-dimethylacetamide; carbamates such as 3-methyl-2-oxazolidone; sulfur-containing compounds, such as sulfolane, dimethyl sulfoxide, and 1,3-propanesultone; and any of the above organic solvents with an introduced fluorine substituent. A combination of 2 or more thereof may be also used as an organic solvent.

The concentration of an electrolyte in a nonaqueous electrolytic solution is usually approx. 0.1 to 2 mol/L, and preferably approx. 0.3 to 1.5 mol/L.

According to the present invention, an electrolyte may be used in a condition that the nonaqueous electrolytic solution is retained by a polymer, namely as a gel electrolyte, or used in a solid condition, namely as a solid electrolyte. As a solid electrolyte, for example, an organic solid electrolyte, in which the electrolyte is retained by a polyethylene oxide type polymer, or a polymer containing at least one of a polyorganosiloxane chain and a polyoxyalkylene chain, can be used. Further, an inorganic solid electrolyte, such as Na₂S—SiS₂, Na₂S—GeS₂, NaTi₂(PO₄)₃, NaFe₂(PO₄)₃, Na₂(SO₄)₃, Fe₂(SO₄)₂(PO₄), Fe₂(MoO₄)₃, β-alumina, β″-alumina, and NASICON, may be used.

(4) Separator

As a separator, a material in a form, such as a porous film, nonwoven fabric, and woven cloth, made of a polyolefin resin, such as polyethylene and polypropylene, a fluorinated resin, a nitrogen-containing aromatic polymer, and the like, may be used, and a separator may be made of 2 or more kinds of the above materials or may be laminated. Examples of a separator include separators described in, for example, Japanese Laid-open Patent Publication No. 2000-30686, and Japanese Laid-open Patent Publication No. H10-324758. It is preferable that the thickness of a separator is thinner, insofar as the mechanical strength remains, in terms of increasing the volumetric energy density of a battery, and of decreasing the internal resistance. The thickness of a separator is usually approx. 5 to 200 μm, and preferably approx. 5 to 40 μm.

A separator uses preferably a porous film containing a thermoplastic resin. With respect to a sodium secondary battery, in the event an abnormal current flows in a battery by reason of short circuit between a positive electrode and a negative electrode and the like, it is usually important to block the current to prevent the excessive current flow (shut down). Consequently, a separator is required to shut down at a lower temperature when it exceeds a normal operating temperature (in the case a separator uses a porous film containing a thermoplastic resin, micropores in the porous film are occluded), and, after shut down, to maintain the shut down condition even if the temperature in the battery rises to a certain high temperature without causing film breakage at such a temperature, and namely, heat resistance of separator is required to be high.

Thermal film breakage can be prevented by using a separator of a laminated porous film which is a laminate of a heat-resistant porous layer containing a heat-resistant resin and a porous film containing a thermoplastic resin, as the separator. In this regard, both the faces of the porous film may be laminated with heat-resistant porous layers.

A sodium secondary battery can be produced by preparing an electrode assembly by laminating and winding around a positive electrode, a separator, and a negative electrode, placing the assembly into a case such as a battery cell, and impregnating therein the nonaqueous electrolytic solution.

Examples of the shape of the electrode assembly in terms of the shape of a cross-section of the electrode assembly cut vertical to the winding axis include a circular shape, an elliptical shape, a rectangular shape, and a rounded rectangular shape. Examples of the battery shape include paper, coin, cylindrical, and prismatic shapes.

Although a sodium secondary battery, in which a first electrode is a negative electrode and a second electrode is a positive electrode, is described above, the first electrode may be a positive electrode and the second electrode may be a negative electrode. In the case of a sodium secondary battery where the first electrode is a positive electrode and the second electrode is a negative electrode, the second electrode may be an electrode made of sodium metal or a sodium alloy.

### EXAMPLES

The present invention will be described in more details below by way of Examples, and the present invention is not limited to the following Examples insofar as the spirit of the invention is not departed.

### Example 1

### Production of Carbon Material

A nitrogen atmosphere was introduced in a ring furnace and, with circulation of a nitrogen gas at a rate of 0.1 L/g (mass of phenolphthalein) per minute, phenolphthalein (Guaranteed grade reagent: bought from Wako Pure Chemical Industries, Ltd.) was heated from room temperature to 1000° C. at a rate of 5° C. per minute, then kept at 1000° C. for 1 hour with circulation of a nitrogen gas at a rate of 0.1 L/g (mass of phenolphthalein) per minute, and cooled to yield a carbon material. Thereafter, the material was milled with a ball mill (agate balls, 28 rpm, and 5 min) to yield a powdery carbon material CM¹.

(Production of Sodium Secondary Battery and Evaluation of the Same)

A mixture of 97 parts of the yielded carbon material CM¹ and 3 parts of sodium polyacrylate together with an appropriate amount of water was kneaded, then coated on a current collector, for which a 10 μm-thick foil of Cu was used, by an automatic applicator to a coat mass of 4 mg per 1 cm² of CM¹, and pre-dried at 60° C. for 1 hour. Then the dried coated product was rolled by a roll press and cut to a disk with the diameter of 1.5 cm and dried in a vacuum at 150° C. for 8 hours to yield an electrode EA¹. The yielded electrode EA¹ after drying in a vacuum was used as a positive electrode, a Na foil as a negative electrode, a polyethylene microporous membrane as a separator, and 1 mol/L-concentration NaPF₆/propylene carbonate as an electrolytic solution respectively. Then using a coin cell of a CR2032 type (JIS standard), a sodium secondary battery NB¹ was assembled.

Using a charge discharge evaluation apparatus, the sodium secondary battery was charged by a constant-current charge with a current density of 18 mA/g up to 0.005 V, after having reached 0.005 V by a constant-voltage charge at 0.005 V for 30 hours in terms of the total charge time including the constant-current charge, and then discharged at a constant current with a current density of 18 mA/g until reaching 1.5 V, while the total electrical power discharged during the discharge period was measured to find that the first discharge capacity was 255 mAh/g.

(Production of Sodium Secondary Battery and Evaluation of the Same)

(Production of Positive Electrode Active Material AMC)

In a polypropylene beaker, 44.88 g of potassium hydroxide was added into 300 mL of distilled water and dissolved with stirring until the potassium hydroxide was completely dissolved, to prepare an aqueous solution of potassium hydroxide (precipitant). In another polypropylene beaker 21.21 g of iron(II) chloride tetrahydrate, 19.02 g of nickel(II) chloride hexahydrate, and 15.83 g of manganese(II) chloride tetrahydrate were added to 300 mL of distilled water and dissolved with stirring to yield an aqueous solution containing iron-nickel-manganese. Into the precipitant the aqueous solution containing iron-nickel-manganese was dropped by stirring to yield a slurry with formed precipitates. Next, the slurry was filtrated and washed with distilled water, and then dried at 100° C. to obtain a precipitate. The precipitate and sodium carbonate were weighed out to a molar ratio of Fe:Na=0.4:1 and dry-blended in an agate mortar to obtain a mixture. Then the mixture was placed in an alumina calcination container, calcined in an electric oven at 900° C. for 6 hours in the air atmosphere, and chilled to room temperature to yield a positive electrode active material AMC. According to a powder X-ray diffraction analysis of the positive electrode active material AMC, it has been known that it is a crystal structure of α-NaFeO₂ type. Further, the composition of the positive electrode active material AMC was analyzed by ICP-AES to find that the molar ratios of Na:Fe:Ni:Mn were 1:0.4:0.3:0.3.

(Production of Electrode EC¹)

In order to produce an electrode mixture paste, the AMC as a positive electrode active material, acetylene black (HS100, by Denki Kagaku Kogyo Kabushiki Kaisha) as an electroconductive material, a solution of PVdF #7305 (by Kureha Corporation) as a binding agent, and NMP (Lithium battery grade, by Kishida Chemical Co., Ltd.) as an organic solvent were used. They were weighed out to the composition of: the positive electrode active material AMC:an electroconductive agent:the binding agent:NMP=90:6:4:100 (by mass), and stirred and mixed by T. K. FILMIX Model 30-25 (by PRIMIX Corp.) to yield an electrode mixture paste P¹. The rotation conditions of a rotating wheel were set at 5,000 rpm for 3 min.

Using a 20 μm-thick Al foil as a positive electrode current collector, the paste was coated by a doctor blade process on the current collector, and pre-dried at 60° C. for 1 hour. Then the dried coated product was rolled with a roll press and cut to a disk having a diameter of 1.45 cm and dried in a vacuum at 150° C. for 8 hours to yield an electrode EC'.

(Production of Sodium Secondary Battery)

The electrode EA¹ was used as a negative electrode, the electrode EC¹ as a positive electrode, a polyethylene macroporous membrane as a separator, and 1 mol/L-concentration NaPF₆/propylene carbonate as an electrolytic solution respectively. Then using a coin cell of a CR2032 type (IEC/JIS standard), a sodium secondary battery NIB¹ was assembled.

Using a charge discharge evaluation apparatus, the sodium secondary battery, using the electrode EA¹ as a negative electrode, and the electrode EC¹ as a positive electrode, was charged by a constant-current charge with a current density of 36 mA/g up to 4.0 V (based on a negative electrode active material), after having reached 4.0 V by a constant-voltage charge at 4.0 V for 12 hours in terms of the total charge time including the constant-current charge. Then the battery was discharged at a constant current with a current density of 36 mA/g (based on a negative electrode active material) until reaching 1.5 V.

### Example 2

### Production of Carbon Material

An argon atmosphere was introduced in a calcination furnace and, with circulation of an argon gas at a rate of 0.1 L/g per minute, the carbon material CM¹ yielded in Example 1 was heated from room temperature to 1600° C. at a rate of 5° C. per minute, then kept at 1600° C. for 1 hour with circulation of a nitrogen gas at a rate of 0.1 L/g per minute, and cooled to yield a carbon material CM².

(Production of Sodium Secondary Battery and Evaluation of the Same)

Using the carbon material CM², a circular electrode EA² with the diameter of 1.5 cm was produced identically with Example 1 to have a mass of the carbon material CM² per 1 cm² of 5 mg. The yielded electrode EA² was used as a positive electrode, a Na foil as a negative electrode, a polyethylene microporous membrane as a separator, and 1 mol/L-concentration NaPF₆/propylene carbonate as an electrolytic solution respectively. Then using a coin cell of a CR2032 type (JIS standard), a sodium secondary battery NB² was assembled.

Using a charge discharge evaluation apparatus, the coin cell was charged by a constant-current charge with a current density of 18 mA/g up to 0.005 V, after having reached 0.005 V by a constant-voltage charge at 0.005 V for 30 hours in terms of the total charge time including the constant-current charge, and then discharged at a constant current with a current density of 18 mA/g until reaching 1.5 V, while the total electrical power discharged during the discharge period was measured to find that the first discharge capacity was 315 mAh/g.

(Production of Sodium Secondary Battery and Evaluation of the Same)

An electrode EC² was produced identically with the electrode EC¹ in Example 1.

The electrode EA² was used as a negative electrode, the electrode EC² as a positive electrode, a polyethylene microporous membrane as a separator, and 1 mol/L-concentration NaPF₆/propylene carbonate as an electrolytic solution respectively. Then using a coin cell of a CR2032 type (IEC/JIS standard), a sodium secondary battery NIB² was assembled.

Using a charge discharge evaluation apparatus, the NIB², using the electrode EA² as a negative electrode, and the electrode EC² as a positive electrode, was charged by a constant-current charge with a current density of 36 mA/g up to 4.0 V (based on a negative electrode active material), after having reached 4.0 V by a constant-voltage charge at 4.0 V for 15 hours in terms of the total charge time including the constant-current charge. Then the battery was discharged at a constant current with a current density of 36 mA/g (based on a negative electrode active material) until reaching 1.5 V.

### Example 3

### Production of Carbon Material

An argon atmosphere was introduced in a calcination furnace and, with circulation of an argon gas at a rate of 0.1 L/g per minute, the carbon material CM¹ yielded in Example 1 was heated from room temperature to 2000° C. at a rate of 5° C. per minute, then kept at 2000° C. for 1 hour with circulation of a nitrogen gas at a rate of 0.1 L/g per minute, and cooled to yield a carbon material CM³.

(Production of Sodium Secondary Battery and Evaluation of the Same)

Using the carbon material CM³, a circular electrode EA³ with the diameter of 1.5 cm was produced identically with Example 1 to have a mass of the carbon material CM³ per 1 cm² of 5 mg. The yielded electrode EA³ was used as a positive electrode, a Na foil as a negative electrode, a polyethylene microporous membrane as a separator, and 1 mol/L-concentration NaPF₆/propylene carbonate as an electrolytic solution respectively. Then using a coin cell of a CR2032 type (JIS standard), a sodium secondary battery NB³ was assembled.

Using a charge discharge evaluation apparatus, the coin cell was charged by a constant-current charge with a current density of 18 mA/g up to 0.005 V, after having reached 0.005 V by a constant-voltage charge at 0.005 V for 30 hours in terms of the total charge time including the constant-current charge, and then discharged at a constant current with a current density of 18 mA/g until reaching 1.5 V, while the total electrical power discharged during the discharge period was measured to find that the first discharge capacity was 291 mAh/g.

### Example 4

### Production of Carbon Material

A nitrogen atmosphere was introduced in a ring furnace and, with circulation of an argon gas at a rate of 0.1 L/g (mass of phenolphthalein) per minute, phenolphthalein (Guaranteed grade reagent: bought from Wako Pure Chemical Industries, Ltd.) was heated from room temperature to 1600° C. at a rate of 5° C. per minute, then kept at 1600° C. for 1 hour with circulation of an argon gas at a rate of 0.1 L/g (mass of phenolphthalein) per minute, and cooled to yield a carbon material. Thereafter, the material was milled with a ball mill (agate balls, 28 rpm, and 5 min) to yield a powdery carbon material CM⁴.

(Production of Sodium Secondary Battery and Evaluation of the Same)

A mixture of 97 parts of the yielded carbon material CM⁴ and 3 parts of sodium polyacrylate together with an appropriate amount of water was kneaded, then coated on a current collector, for which a 10 μm-thick foil of Cu was used, by an automatic applicator to a coat mass of 4 mg per 1 cm² of CM⁴, and pre-dried at 60° C. for 1 hour. Then the dried coated product was rolled by a roll press and cut to a disk with the diameter of 1.5 cm and dried in a vacuum at 150° C. for 8 hours to yield an electrode EA⁴. The yielded electrode EA⁴ after drying in a vacuum was used as a positive electrode, a Na foil as a negative electrode, a polyethylene microporous membrane as a separator, and 1 mol/L-concentration NaPF₆/propylene carbonate as an electrolytic solution respectively. Then using a coin cell of a CR2032 type (JIS standard), a sodium secondary battery NB⁴ was assembled.

Using a charge discharge evaluation apparatus, the sodium secondary battery was charged by a constant-current charge with a current density of 18 mA/g up to 0.005 V, after having reached 0.005 V by a constant-voltage charge at 0.005 V for 30 hours in terms of the total charge time including the constant-current charge, and then discharged at a constant current with a current density of 18 mA/g until reaching 1.5 V, while the total electrical power discharged during the discharge period was measured to find that the first discharge capacity was 231 mAh/g.

### Example 5

### Production of Sodium Secondary Battery and Evaluation of the Same

The electrode EA² yielded in Example 2 was used as a positive electrode, a Na foil as a negative electrode, a polyethylene microporous membrane as a separator, and 1 mol/L-concentration NaPF₆/mixed solvent (ethylene carbonate:dimethyl carbonate=50 vol-%:50 vol-%) as an electrolytic solution respectively. Then using a coin cell of a CR2032 type (JIS standard), a sodium secondary battery NB⁵ was assembled.

Using a charge discharge evaluation apparatus, the sodium secondary battery was charged by a constant-current charge with a current density of 18 mA/g up to 0.005 V, after having reached 0.005 V by a constant-voltage charge at 0.005 V for 30 hours in terms of the total charge time including the constant-current charge, and then discharged at a constant current with a current density of 18 mA/g until reaching 1.5 V, while the total electrical power discharged during the discharge period was measured to find that the first discharge capacity was 311 mAh/g.

### Example 6

### Production of Sodium Secondary Battery and Evaluation of the Same

The electrode EA² yielded in Example 2 was used as a positive electrode, a Na foil as a negative electrode, a polyethylene microporous membrane as a separator, and 1 mol/L-concentration NaClO₄/mixed solvent (ethylene carbonate:dimethyl carbonate=50 vol-%:50 vol-%) as an electrolytic solution respectively. Then using a coin cell of a CR2032 type (JIS standard), a sodium secondary battery NB⁶ was assembled.

Using a charge discharge evaluation apparatus, the sodium secondary battery was charged by a constant-current charge with a current density of 18 mA/g up to 0.005 V, after having reached 0.005 V by a constant-voltage charge at 0.005 V for 30 hours in terms of the total charge time including the constant-current charge, and then discharged at a constant current with a current density of 18 mA/g until reaching 1.5 V, while the total electrical power discharged during the discharge period was measured to find that the first discharge capacity was 317 mAh/g.

### Comparative Example

A powder of a phenolic resin (SUMILITE resin, PR-217) on an alumina boat was placed in a ring furnace and kept at 1000° C. in an argon gas atmosphere for carbonizing the phenolic resin powder. In doing so, the flow rate of an argon gas in the furnace was 0.1 L/min per 1 g of the phenolic resin powder, the rate of temperature increase from room temperature to 1000° C. was approx. 5° C./rain, and the retention time at 1000° C. was 1 hour. After the carbonization, the product was milled in a ball mill (agate balls, 28 rpm, and 5 min) to yield a powdery carbon material RCM¹. The average particle size was 50 μm or less.

(Production of Negative Electrode for Sodium Secondary Battery and Evaluation of Single Cell Thereof)

Using the carbon material RCM¹, a circular electrode REA¹ with the diameter of 1.5 cm was produced identically with Example 1. The yielded electrode REA¹ was used as a second electrode, a Na foil as a first electrode, a polyethylene microporous membrane as a separator, and 1 mol/L-concentration NaClO₄/propylene carbonate as an electrolytic solution respectively. Then using a coin cell of a CR2032 type (JIS standard), a sodium secondary battery RNB¹ was assembled.

Using a charge discharge evaluation apparatus, the coin cell was charged by a constant-current charge with a current density of 18 mA/g up to 0.005 V, after having reached 0.005 V by a constant-voltage charge at 0 V for 12 hours in terms of the total charge time including the constant-current charge, and then discharged at a constant current with a current density of 18 mA/g until reaching 1.5 V, while the total electrical power discharged during the discharge period was measured to find that the first discharge capacity was 245 mAh/g.

1. A production method of a carbon material for a sodium secondary battery comprising heating at a temperature of 800 to 2500° C. one or more organic compounds selected from the group consisting of an organic compound 1 and an organic compound 2;
wherein the organic compound 1 is an organic compound represented by the formula (1), the formula (2), or the formula (3), and having 2 or more oxygen atoms in the each formula: 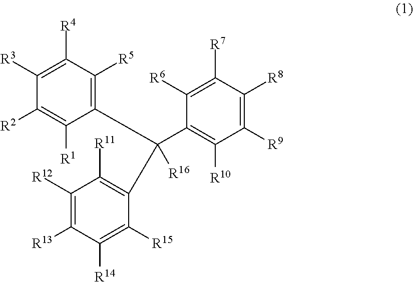
wherein R¹ to R¹⁶ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group,
wherein R⁵ and R⁶ together may represent —O—, and
wherein R¹⁵ and R¹⁶ together may represent —CO—O— or —SO₂—O—; 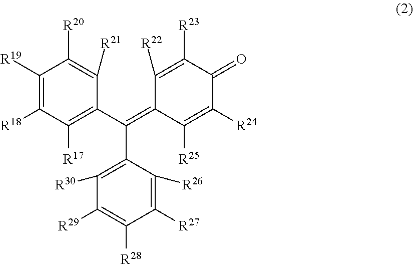
wherein R¹⁷ to R³⁰ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group, and
wherein R²¹ and R²² together may represent —O—; 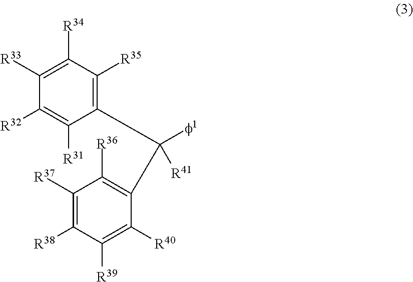
wherein R³¹ to R⁴¹ represent a hydrogen atom, a hydroxy group, an alkoxy group, an acyl group, a halogeno group, an optionally substituted alkyl group, an optionally substituted aromatic hydrocarbon group, or an optionally substituted aromatic heterocyclic group,
wherein R⁴⁰ and R⁴¹ together may represent —CO—O— or —SO₂—O—, and
wherein φ¹ represents an optionally substituted allyl group, an optionally substituted cyclopentadiene group, or an optionally substituted aromatic heterocyclic group; and
wherein the organic compound 2 is a mixture of an aromatic derivative 1 having an oxygen atom in the molecule and an aromatic derivative 2 having a carboxyl group in the molecule and being different from the aromatic derivative 1.

2. The production method according to claim 1, wherein, as to the organic compound 1, R⁵ and R⁶ together represents —O—, and/or R¹⁵ and R¹⁶ together represents —CO—O— or —SO₂—O— in the formula (1).

3. The production method according to claim 1, wherein any one of R¹ to R⁵ is a hydroxy group, an alkoxy group, or an acyl group, and any one of R⁶ to R¹⁰ is a hydroxy group, an alkoxy group, or an acyl group.

4. The production method according to claim 1, wherein any one of R¹⁷ to R²¹ is a hydroxy group, an alkoxy group, or an acyl group, and any one of R²² to R²⁵ is a hydroxy group, an alkoxy group, or an acyl group.

5. The production method according to claim 1, wherein, as to the organic compound 2, the aromatic derivative having an oxygen atom is phenol, resorcinol, or cresol, and the aromatic derivative having a carboxyl group is phthalic anhydride.

6. A sodium secondary battery comprising a first electrode including the carbon material for a sodium secondary battery produced by the production method according to claim 5, and a binding agent; a second electrode; and an electrolyte.

7. The sodium secondary battery according to claim 6, wherein the second electrode comprises a transition metal compound containing sodium represented by the following formula (A):
NaₓMO₂ (A)
wherein M is at least one element selected from the group consisting of Fe, Ni, Co, Mn, Cr, V, Ti, B, Al, Mg and Si; and x is more than 0 but not more than 1.2.

8. The sodium secondary battery according to claim 6, wherein the binding agent comprises a non-fluorinated resin.
